(19) United States
(12) Patent Application Publication
(10) Pub. No.: US 2016/0044572 A1
(43) Pub. Date: Feb. 11, 2016

(54) OPERATION OF A MULTI BEARER DEVICE IN AN LMR NETWORK

(71) Applicant: Niall McAndrew, Christchurch (NZ)

(72) Inventor: Niall McAndrew, Christchurch (NZ)

(21) Appl. No.: 14/818,712

(22) Filed: Aug. 5, 2015

(30) Foreign Application Priority Data
Aug. 5, 2014 (NZ) 628342

(51) Int. Cl. H04W 40/22; H04L 29/12

(52) U.S. Cl. CPC H04W 40/22; H04L 61/2592

(57) ABSTRACT

A communication system that enables remotely located LMR terminals to take part in calls within a normal LMR network using an intermediate bearer. A multi bearer device enables local direct mode communications from the terminal to use an IP backhaul network. LMR content may be received by the device and converted to an IP stream. Similarly an IP stream may be received by the device and transmitted to the LMR terminal. The system requires interconnected LMR and IP networks with the multi bearer device acting as a relay.

### CROSS-REFERENCE TO RELATED APPLICATIONS

This patent application claims the priority of New Zealand Provisional Patent Application No. NZ628342, filed Aug. 5, 2014, the disclosure of which is incorporated by reference in its entirety for all purposes.

### FIELD OF THE INVENTION

This invention relates to achieving range extension for land mobile radio (LMR) communications using other technology as an intermediate bearer. A multi bearer device enables LMR traffic or control signals to be sent through an IP network.

### BACKGROUND TO THE INVENTION

Public safety agencies around the world typically use relatively narrow band technologies such as P25 to communicate voice information. This technology is characterised as being long range and offering high quality voice. Today, Public Safety is considering the use of new technologies, such as LTE, capable of high rate data enabling mobile data applications. This form of technology is relatively short range compared to narrow band technologies. In a move to capture the benefit of both technologies, methods of integration are being considered.

Typically, LMR systems are deployed over wide area where public safety operation is expected including both populated and unpopulated areas. Typically, cellular systems are deployed over populated areas or areas where revenue can be generated through user traffic. There exist areas where LMR exists but no cellular. There exist areas where cellular exists but no LMR. There exist areas where both LMR and cellular exist. Historically there have been innovations that seek to selectively communicate over either cellular or LMR depending upon which bearer is available.

Previous attempts to extend the range of LMR generally use the same bearer type. One example might be P25 repeater wherein data receiving on one P25 channel is re-transmitted on another P25 channel.

### SUMMARY OF THE INVENTION

It is an object of the invention to provide a method of extending the operation of an LMR network through using an intermediate bearer, generally an IP capable broadband bearer such as cellular, as either one or more extra channels or simply as a backhaul.

In one aspect the invention provides a method of extending the range of LMR using cellular coverage. In effect, the cellular technology becomes an extra communication pipe through which to enable communication. In particular, we focus on P25 and LTE. However, generally any LMR bearer can be used on one side and any IP capable bearer can be used on the other.

In another aspect the invention includes an architecture used to relay traffic communicated over an LMR system across a cellular system back through to an LMR core network. This enables an LMR radio to operate in areas where LMR coverage may not be available from an LMR cell site. A multi-bearer device acts as a relay for the originating LMR signal.

The LMR bearer may be P25 (APCO 25), Tetra, DMR (Digital Mobile Radio) or generally any form of relatively narrow band bearer. The intermediate bearer used to relay the LMR signal may be LTE (3GPP Long Term Evolution) or Wifi or generally any form of wireless bearer of capable data rates to communicate IP packets.

In another aspect, the invention resides in an ability to establish normal individual and group calls in a conventional P25 mode to a core network that is not directly P25 RF connected. Generally, conventional P25 means the allocation of the channel is predefined by the radio configuration. Preferentially this enables of remote devices to operate take part of normal group or individual calls with devices also connected on a physical RF network.

In a further aspect, the invention may enable a control channel of a trunked P25 system to operate over a cellular IP pipe whereas traffic channels to operate over normal P25 channels. Preferentially this can minimise the congestion on said control channel.

Alternatively a traffic channel of a trunked P25 system may operate over a cellular IP pipe whereas control channels operate over normal P25 channels. Preferentially this enables the expansion of P25 channels available.

### LIST OF FIGURES

Preferred embodiments of the invention will be described with respect to the accompanying drawings, of which:

FIG. 1 is an overview of the way standard P25 terminals can connect to an LMR core network over a cellular system.

FIG. 2 is an overview of the way in which a multi bearer device can extend the range of LMR further than the edge of a cellular system.

FIG. 3 is an overview of the way in which the multi bearer device can enable normal P25 group communications from normal P25 devices in the absence of P25 RF channels.

FIG. 4 shows the protocols used to enable connectivity from a P25 terminal through a relay to the core network.

FIG. 5 illustrates detail of the P25 information stream being passed out of the relay terminal.

FIG. 6 illustrates the structure of a typical P25 transmission.

FIG. 7 is a flow diagram showing operation of the device in conventional mode.

FIG. 8 shows a sequence diagram of call establishment and information flow from an LMR device through the device.

FIG. 9 shows a sequence diagram of a call establishment and information flow to an LMR device through the device.

FIG. 10 illustrates the architecture of the device.

### DESCRIPTION OF PREFERRED EMBODIMENTS

Referring to the drawings it will be appreciated the invention may be performed in a variety of ways using a number of platforms that relay information across from an LMR device through an IP capable network to an LMR system.

In this example APCO P25 forms the LMR system. In general terms however any form of LMR could be used including Terrestrial Trunked Radio (TETRA), Opensky, NetworkFirst, Enhanced Digital Access Communications System (EDACS) and Digital Mobile Radio (DMR). Further, the IP capable platform may be any data capable cellular system capable of delivering high data rates to enable IP communications. Examples includes 3GPP standards such as LTE as well as other standards such as 3GPP2, WiMax and WLAN.

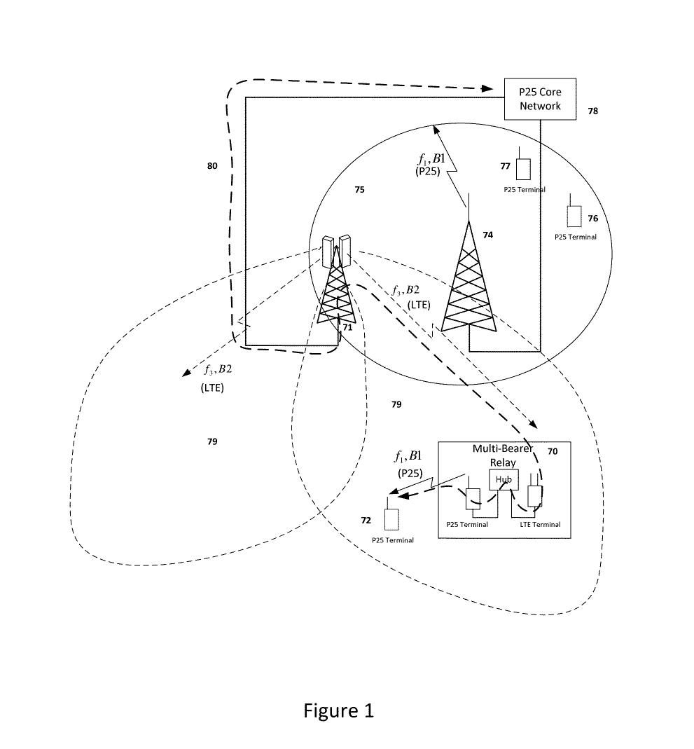

FIG. 1 illustrates the main components of a system that includes a multi bearer device or relay which enables an intermediate bearer. The relay 70 includes a normal P25 terminal and an LTE terminal connected via a processor capable of processing information between the units. The relay is within the coverage area 79 of a cellular tower 71. A P25 terminal 72 that is also within the coverage area 79 of the cellular network, initiates an LMR communication containing LMR content. Terminal 72 preferably establishes a direct mode connection to the P25 terminal contained within the relay 70. Direct mode means a direct connection is made from radio to radio in the absence of a network infrastructure. Within the industry this is referred in a number of ways including direct mode and talk around. Preferentially this enables the standard P25 terminal 72 that is not in coverage of an LMR network 78 to establish a normal LMR call to an LMR network 78 and population of LMR terminals.

Within the relay 70, the processing hub will establish an IP connection to the LMR core network 78 with which to communicate P25 information. This IP connection is established over any IP capable bearer with sufficient bandwidth to carry the information. In this case we connect over an LTE or 4G cellular network via a cellular tower 71 through an IP network 80 to a P25 core network 78. Through the P25 core network 78, the information can be retransmitted over a local LMR network via an LMR tower 74 to one or more P25 terminals 76, 77 within the coverage area of the LMR network 75.

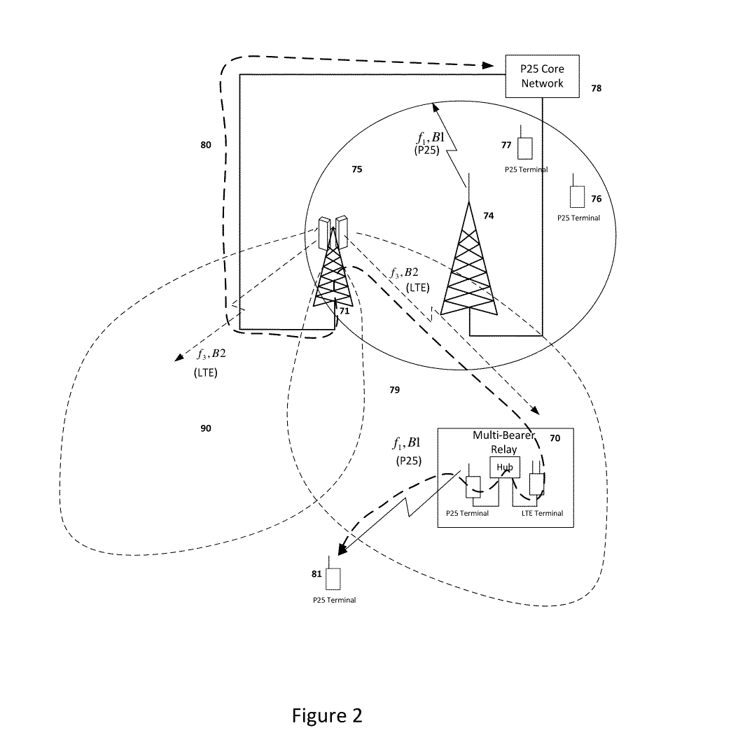

FIG. 2 illustrates a scenario similar to FIG. 1 except a P25 terminal 81 is now outside the coverage area of the cellular network, 79. In this case the terminal establishes a direct mode connection to the relay 70 and establishes a call in the same way described above.

Preferentially, this configuration enables extended range operation beyond the edge of the cellular network 79 for a P25 terminal connecting to an LMR network 78. This includes cases where cellular connectivity may not exist within a building where as the use of the P25 direct mode connection to the relay 70 enables normal LMR operation.

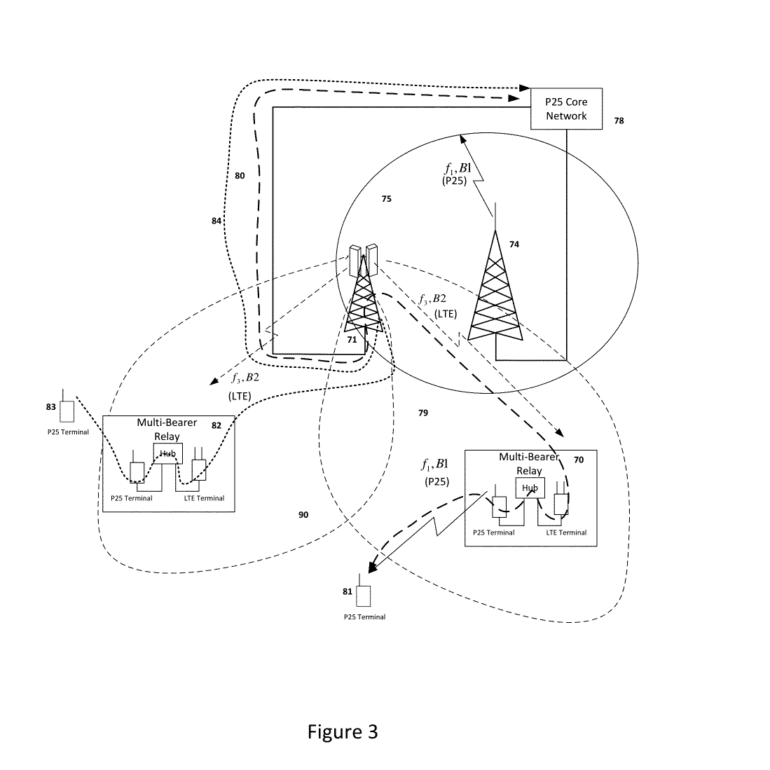

FIG. 3 shows another example wherein a relay 70 exists within the cellular coverage area 79 and another relay 82 exists within another cellular coverage area 90. In this case a P25 terminal 81 establishes a direct mode connection with the relay 70 which establishes an IP connection to the core network 78 with which to communicate the P25 information from terminal 81. Further, terminal 82 establishes a direct mode connection to a relay 82 and the relay establishes an IP connection to the core network 78 with which to communicate the P25 information from terminal 82. Preferentially, this configuration enables a group of P25 terminals that are operating outside of range of an LMR network to participate in a communications with an LMR network.

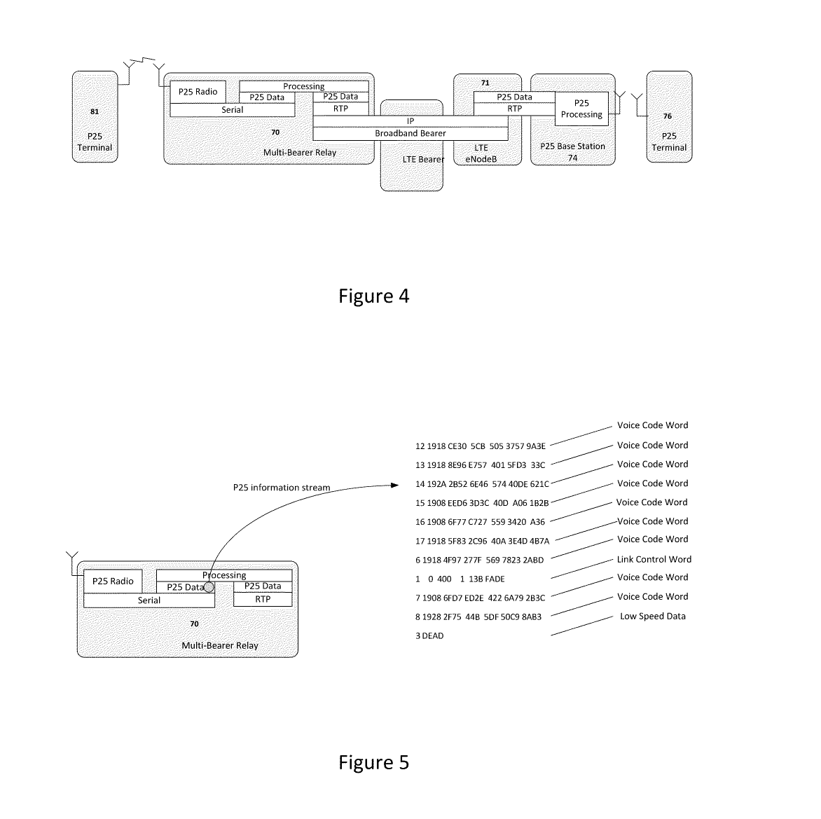

FIG. 4 illustrates more detail of the protocols which may be used to realise the invention. A P25 terminal 81 communicates via direct mode to the relay 70. The P25 information is received by the P25 device within the relay 70 and is streamed out over the serial port to an associated processing hub. The processing hub reformats the information in a way that is ready to be used in a target base station. Here, we use one particular format but clearly any format can apply. The processor sends the reformatted P25 data through using RTP (Real Time Protocol) over an IP pipe supported by a suitable broadband bearer, in this case LTE. Upon reception at an LTE base station 71 the P25 data is communicated to the P25 base station 74 via an IP path ready for normal decoding. Base station 74 transmits to a P25 terminal 76.

It should be noted that some implementations of base station can also operate in a voting mode. In this mode a voter can select with alternative inputs wherein at least one input can come via an IP path from another base station. As a result, the processing hub described herein may be said to be operating in a mode where it is simulating another base station. It should also be noted that control signals and traffic signals are treated in generally the same way by the multi-bearer device.

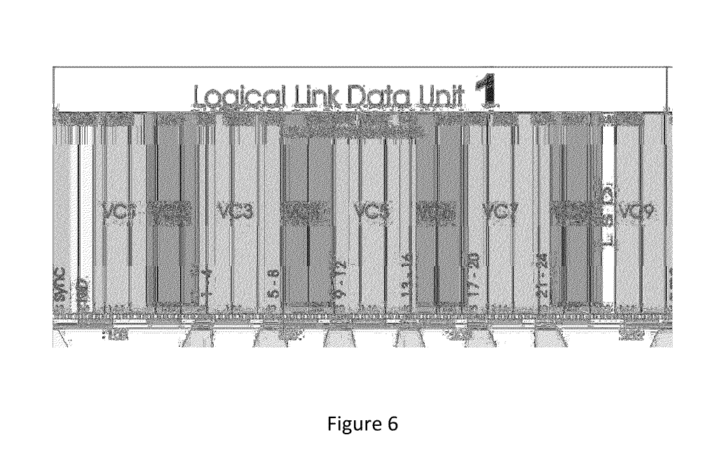

FIG. 5 shows more detail of one particular implementation of the multi bearer device or relay 70. In this case, the data obtained through the radio serial port appears in streams of 18 voice code words, a low speed data (LSD) code word, a link control word and an encryption sync word. This information stream represents the key components of a P25 Logical Link Data Unit (LDU) as shown in FIG. 6. The combination of two LDUs, LDU1 and LDU 2 make up a super frame.

FIG. 5 shows an example of the data stream available at the radio serial port when the P25 radio is operating in a relay mode. Associated with each code word is a convenient sequence number—in this case 3 represents the LSD and 6 indicates voice code words. These are vocoded. To process the code words into a form suitable for a base station receiving data over an IP port, each component must be identified separately. When the link control word LSD or the encryption sync word is identified, it is encoded with Reed-Solomon 24, 12, 13. The link control word, encryption sync word and LSD are forward error corrected. This is simply because a current implementation at the base station requires such a structure to decode.

Once a super frame link control word and encryption sync word have been received from the radio, then the IP packets can be built. Formation and deformation of IP packets may be carried out by encapsulation and decapsulation. A special RTP header is created for each packet containing information including frame type and number of payloads. Each packet is given a voice code word (in sequential order) as a payload, and depending on the frame type of the packet, might be given the LSD or part of the encryption sync word or link control word as a second payload. For example frame type 63 is just voice code word 2, but frame type 65 contains part of the link control word as well. Frame type 62 must also contain stream information.

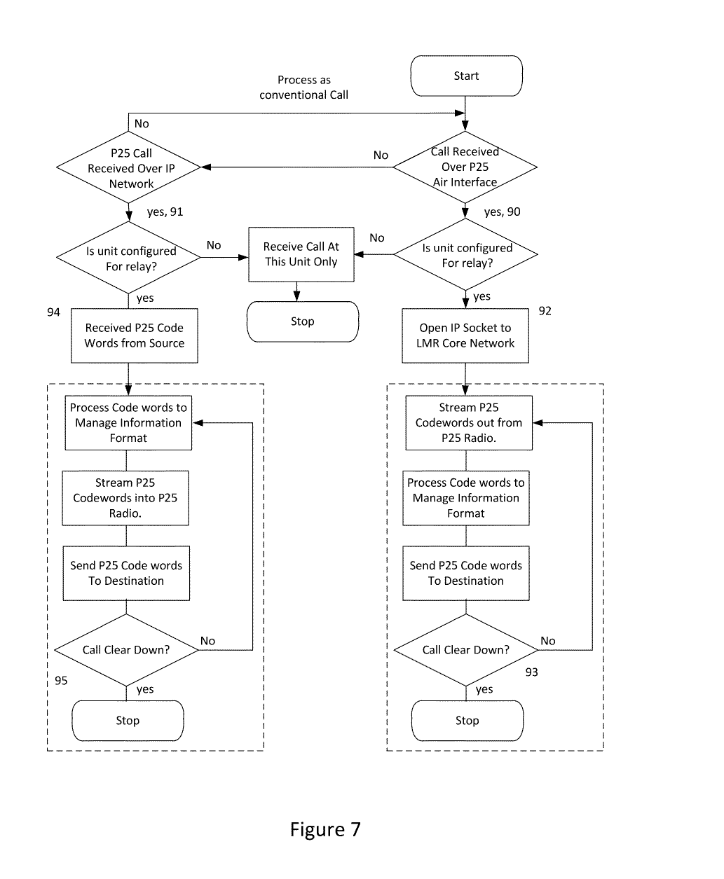

FIG. 7 is a flow diagram for operation of the multi bearer device such as shown in FIG. 3. Initially the system is waiting until a call starts. That call can be initiated by a communication 90 over the RF port, through a communication 91 over an IP path, or by initiation at the device itself. A call typically proceeds with transmission of LMR content in both directions although only the initial steps of establishing a call are described in detail.

In one case a terminal A has initiated a call 90 to a group which includes a terminal B in a remote location not within range of the current direct mode RF communication. Terminal A has initiated the call using direct mode over the local RF interface. Other terminals within range of Terminal A and within the group will also detect the communication. Others may be out of range of Terminal A but within range of an LMR P25 system some distance away. If the multi bearer device is configured for relay mode it will both unmute the audio information at the relay and simultaneously open an IP connection 92 to a destination. This destination may be a base station that is capable of receiving P25 information through IP. The stream of P25 code words is continuously sent out of the radio, processed according to a format required by the remote base station then transmitted across the IP path to the remote base station. Upon arriving at the remote base station, the stream is retransmitted as normal over the air interface to a remote population of terminals. As a result, Terminal B will also be included in the group call. Practically any terminal affiliated with the group and within range of the base station will also be able to take part in the call. The call proceeds until a normal call clear down 93.

Now the case where remote Terminal B initiates a call 91 to the group. This operates normally over the LMR system via base station communications. In addition however a P25 base station also converts and streams the information via IP to the relay. The P25 base station forms and sends an IP stream to an IP network which sends the stream to the relay. The relay receives 94 a stream of IP packets, retrieves the P25 code words and retransmits the information over the local direct mode channel. Terminal A detects the call setup normally and takes part in the call as does any other terminal affiliated with the group. Call continues until clear down 95.

Finally the case where the relay itself initiates a call. The relay does have a P25 terminal as part of its solution and as such can take part in any call normally. Let us suppose the relay is also affiliated to the group and initiates call to the group. The relay communicates its call over both the RF interface and the IP path simultaneously establishing normal group call communications with both the local terminal A and distant terminal B.

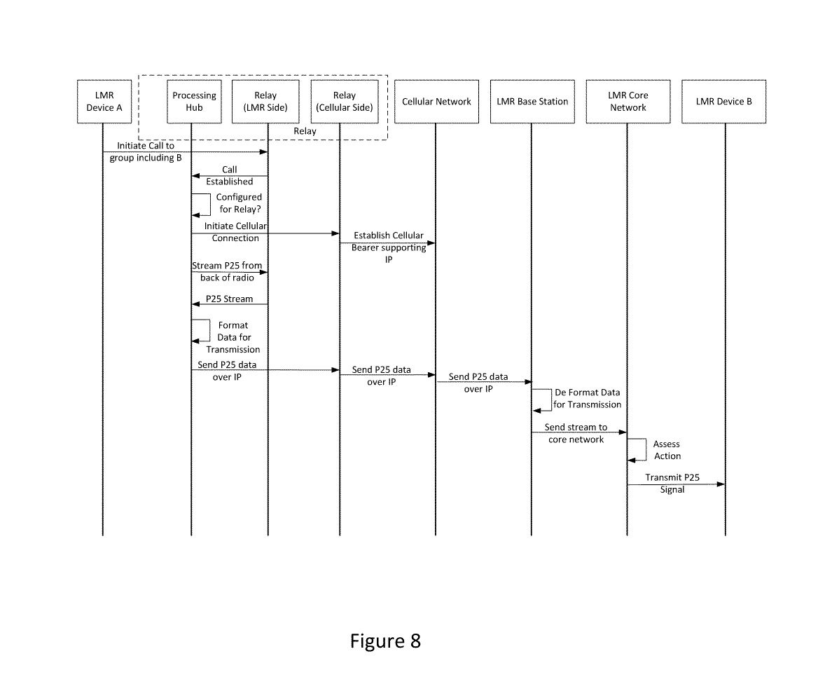

FIG. 8 shows more detail of a process for establishing links between terminal devices using a multi bearer device acting as a relay. LMR terminal A initiates a call in direct mode to a group in its local area. The call is received by the relay which is configured to relay information over the IP port. The relay initiates a cellular connection to a distant base station that is capable of receiving P25 information over an IP port, as IP packets.

An appropriate bearer is established over the cellular network. P25 information in the form of code words is streamed from the radio and processed to set its format such that it is suitable for the remote base station to receive. The information is then streamed continuously to the base station. Subject to normal address verification that can be confirmed by a core network element or directly in the base station, the P25 is retransmitted over the RF interface and detected by Terminal B that is also part of the group.

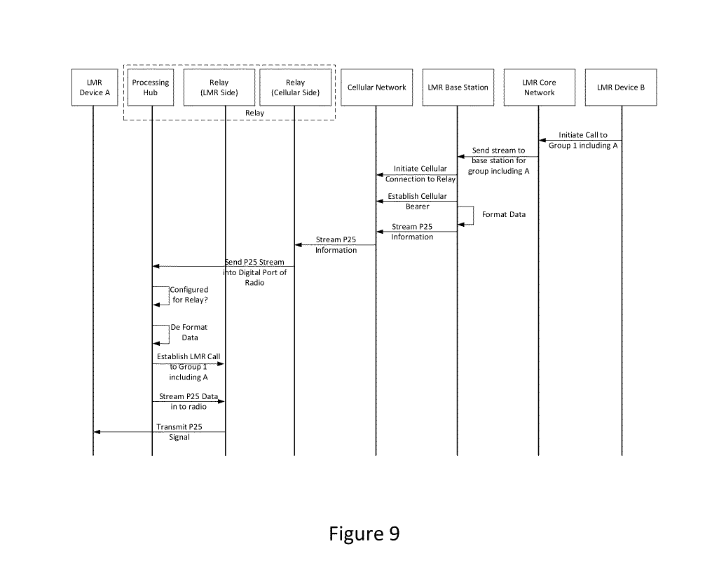

FIG. 9 gives another example wherein a call for a group is established from a remote terminal B. The LMR terminal device B initiates a call over a conventional P25 network to the group in its local area. The call is received by a base station configured to send information over an IP port, as IP packets. The base station initiates a cellular connection to a distant relay that is capable of receiving P25 information over an IP port. An appropriate bearer is established over the cellular network. P25 information in the form of code words is streamed from the base station in a format the remote relay will recognise. Data is received at the relay and retransmitted over a local channel that Terminal A can detect.

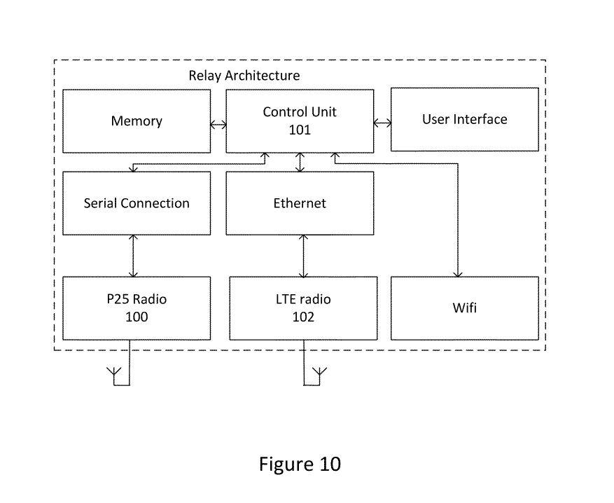

FIG. 10 shows an architecture of a multi bearer device such as shown in FIG. 3. A P25 radio 100 is connected by a serial port to a control unit 101. The control unit receives P25 information, uses a processor to transform the information and transports it across a suitable IP capable bearer. In this case we show an LTE terminal device 102 being available to provide an intermediate bearer. The control unit establishes an IP connection to a remote destination and begins streaming the P25 information to said destination. Also shown as an optional bearer is WiFI (IEEE 802.11). The code used to enable the processing and formatting required to enable the IP connectivity is held with a memory unit. An optional user interface can be added to the system to change configurations.

1. A method of communicating between land mobile radio (LMR) terminals including:
initiating an LMR communication at a first LMR terminal;
receiving LMR content from the first terminal at a multi bearer device having both LMR and IP capability;
forming an IP data stream from the LMR content;
sending the IP stream across an IP network;
sending the IP stream from the IP network to an LMR network;
forming the LMR content from the IP stream; and
sending the LMR content to a second LMR terminal by LMR communication.

2. A method according to claim 1 wherein the LMR communication initiated at the first terminal is a direct mode communication in the absence of an LMR base station.

3. A method according to claim 1 wherein forming the IP data stream includes decoding the LMR content to extract code words and encapsulating the code words as IP packets.

4. A method according to claim 1 wherein forming the LMR content from the IP stream includes decapsulating IP packets to form LMR code words.

5. A method of communicating between land mobile radio (LMR) terminals including:
initiating an LMR communication at a first LMR terminal;
receiving LMR content from the first terminal in an LMR network;
forming an IP data stream from the LMR content;
sending the IP stream from the LMR network to an IP network;
sending the IP stream across an IP network;
receiving the IP stream at a multi bearer device having both LMR and IP capability;
forming the LMR content from the IP stream; and
sending the LMR content to a second LMR terminal by LMR communication.

6. A method according to claim 5 wherein sending the LMR content to the second terminal involves direct mode communication in the absence of an LMR base station.

7. A method of communicating between land mobile radio (LMR) terminals including:
initiating an LMR communication and an IP communication at a multi bearer device having both LMR and IP capability;
receiving LMR content from the device at a first terminal;
forming an IP data stream at the device from the LMR content;
sending the IP stream across an IP network;
sending the IP stream from the IP network to an LMR network;
forming the LMR content from the IP stream; and
sending the LMR content to a second LMR terminal by LMR communication.

8. A method according to claim 7 wherein sending the LMR content to the second terminal involves direct mode communication in the absence of an LMR base station.

9. A multi bearer device for land mobile radio (LMR) communication, comprising:
a first radio for LMR communication;
a second radio for IP communication;
a processor connected to the radios; and
a memory, the memory containing instructions which cause the processor to receive LMR content at the first radio by direct LMR communication from an LMR terminal,
form an outgoing IP data stream from the LMR content,
send the IP stream from the second radio across an IP network,
receive an incoming IP stream at the second radio from the IP network,
form LMR content from the IP stream, and
send the LMR content from the first radio by direct LMR communication to an LMR terminal.

10. A device according to claim 9 wherein the outgoing IP data stream is formed by encapsulation LMR content and the incoming IP stream is formed into LMR content by decapsulation.
